(19) United States
(12) Patent Application Publication
(10) Pub. No.: US 2008/0247537 A1
(43) Pub. Date: Oct. 9, 2008

(54) Reducing interference in DSL service from broadband over powerline signals

(76) Inventors: Paul Henry, Holmdel, NJ (US); Byoung-jo Kim, Freehold, NJ (US)

Correspondence Address: Ms. Lauren Brighton;AT&T Enterprise Services, Inc., Room 3A234H, One AT&T Way, Bedminster, NJ, 07921, US

(21) Appl. No.: 11/732,166

(22) Filed: Apr. 3, 2007

(51) Int. Cl. H04M 7/00

(52) U.S. Cl. 379/416

(57) ABSTRACT

The specification describes a new technique for reducing interference in EDSL signals caused by local BPL transmission lines. It involves sampling the power line signal to derive a noise signal representing the BPL noise causing the EDSL interference, and mixing the BPL noise signal with the EDSL signal to cancel the BPL noise in the EDSL signal. The technique may be implemented by plugging into a conventional home electrical receptacle, and inserting a small noise canceling module in the EDSL line.

Since the method involves an attachment only to the EDSL service, it avoids any involvement with BPL service users and providers.

### FIELD OF THE INVENTION

This invention relates to reducing Broadband over Power Line (BPL) interference on Digital Subscriber Line (DSL) delivery systems.

### BACKGROUND OF THE INVENTION

As customers add new features and capacity to their communications services the demand for broadband (high-speed) connections steadily increases. Two technologies, cable modems and Asymmetric Digital Subscriber Line (ADSL), currently provide most of the enhanced capacity required to fill that demand. While both of these technologies provide Internet connections that are many times faster than a 56K modem, there is still a demand for increased capacity to support many of the imaging and video services currently and prospectively available to on-line subscribers.

An improved DSL technology, very high bit-rate DSL (VDSL), currently under development and recently available commercially, is capable of providing much of the bandwidth needed for new entertainment and business services. VDSL can provide speeds of 50 megabits per second (Mbps), or more, compared with 8 to 10 Mbps for ADSL or cable modem.

Conventional DSL service is typically provided over the familiar copper wire pair installed in nearly every home in the US. The copper wire pair has sufficient bandwidth to carry data in addition to voice. Over short distances, it is capable of providing high bandwidth services.

Enhanced DSL services are available in many formats. Asymmetric DSL (ADSL), already mentioned, is referred to as “asymmetric” because the download speed is greater than the upload speed. ADSL works this way because most Internet users view, or download, much more information than they send. High bit-rate DSL (HDSL) provides transfer rates comparable to a T1 line (about 1.5 Mbps), and receives and sends data at the same speed. However, it requires two lines separate from the standard copper wire pair. ISDN DSL (ISDL) is designed for users of Integrated Services Digital Network (ISDN). It is relatively slow, operating at a rate of 144 Kbps in both directions. An advantage for ISDN customers is that the service uses existing equipment. Multirate Symmetric DSL (MSDSL) is a symmetric form of DSL that is capable of more than one transfer rate. The transfer rate is set by the service provider, typically based on a price schedule. Rate Adaptive DSL (RADSL) is a variation of ADSL that allows the modem to adjust the speed of the connection depending on the length and quality of the line. Symmetric DSL (SDSL), like HDSL, receives and sends data at the same speed and also requires a separate phone line, but only one. Voice-over DSL (VODSL) is a known form of connectivity that allows multiple phone lines to be combined into a single phone line. Very high bit-rate DSL (VDSL) has already been mentioned. This wide variety of enhanced DSL services will be referred to here as EDSL, which term is intended to be generic to the forms just described, as well as others that may be developed. All deliver high-speed data (1 Mbps) over wire lines at the termination. The transmission of the data may include optical fiber and/or coaxial links in the system, but terminate on the users premises on a typical wire pair.

Certain, if not all, of these EDSL options may use frequencies that are susceptible to interference from outside agencies. This is especially the case when a DSL installation also has Broadband over Power Line (BPL) service. Broadband over power lines (BPL), also known as power-line internet or Powerband, is the use of power lines for communications. BPL is used to commercially to provide broadband internet access through ordinary power lines. The communications device, typically a computer, may be simply into any electrical outlet in a BPL-equipped building to have high-speed Internet access. Interference from BPL is a known problem, and has attracted considerable attention from users and providers of other types of delivery systems. See for example,
http://www.arrl.org/tis/info/HTML/pilc/files/Barrv.pdf.

Considerable technical study has been devoted to reducing or eliminating BPL interference. Much of this effort deals with interference issues within the BPL system itself. For consumer networks, a useful data rate starts at 1 Mbps. At this data rate, power lines offer a noisy communications channel. Within a typical residence, the power line is a large and extensive conductor that readily couples to a variety of EMF sources present in the home environment. Consumer products that are plugged into the power distribution system also create noise. This is unavoidable, since these devices alter the impedance of the line, and are constantly changing. Many devices modulate the impedance, making it impossible to transmit a controlled amplitude signal. Local agencies outside of the home, such as CB and amateur radio, seriously interfere with BPL signals. The BPL service providers have addressed the adverse impact on their service caused by these effects. A variety of mitigation techniques, such as the use of filters and protective shielding devices, have been proposed. However, corresponding solutions to the adverse effects on other services caused by BPL signals has been less forthcoming.

In many cases where severe interference effects are encountered in EDSL signals caused by local BPL signals, the two services are provided to the same premises, often sharing interconnection equipment and space. The spatial proximity of service delivery lines for these services causes electromagnetic coupling between the signals. Often they are delivered using the same utility pole, and the drop lines are routed between the pole and the premises along a common path. Underground services may be delivered using common conduits.

Some of the approaches for reducing unwanted interference in EDSL signals caused by local BPL signals raise issues of jurisdiction as well as technical effectiveness. Solutions that involve modification of the BPL equipment cannot be legally implemented without agreement and cooperation, and often intervention, between the two service providers.

Although the effect of BPL signals on other services, like EDSL services, has been investigated, more effective solutions to unwanted interference are still sought. A solution that reduces BPL signal interference on EDSL service that can be implemented independent of the BPL service provider would be especially attractive

### Statement of the Invention

We have developed a new technique for reducing interference in EDSL signals caused by local BPL transmission lines. It involves primarily an attachment to the EDSL service, and thus avoids any involvement of the BPL service users and providers.

The new technique involves sampling the power line signal to derive a noise signal representing the BPL noise causing the EDSL interference, and mixing the BPL noise signal with the EDSL signal to cancel the BPL noise in the EDSL signal. The technique may be implemented by plugging into a conventional home electrical receptacle, and inserting a small noise canceling module in the EDSL line.

### BRIEF DESCRIPTION OF THE DRAWING

The invention may be better understood when considered in conjunction with the drawing in which:

FIG. 1 is a schematic diagram of typical residential installations in which both BPL and EDSL services are provided to customer premises;

FIG. 2 represents a typical noise canceling method;

FIG. 3 is a schematic circuit diagram showing an interference canceling module attached to an EDSL service installation; and

FIG. 4 shows a device configuration where the interference canceler module is integrated with the EDSL modem.

### DETAILED DESCRIPTION OF THE INVENTION

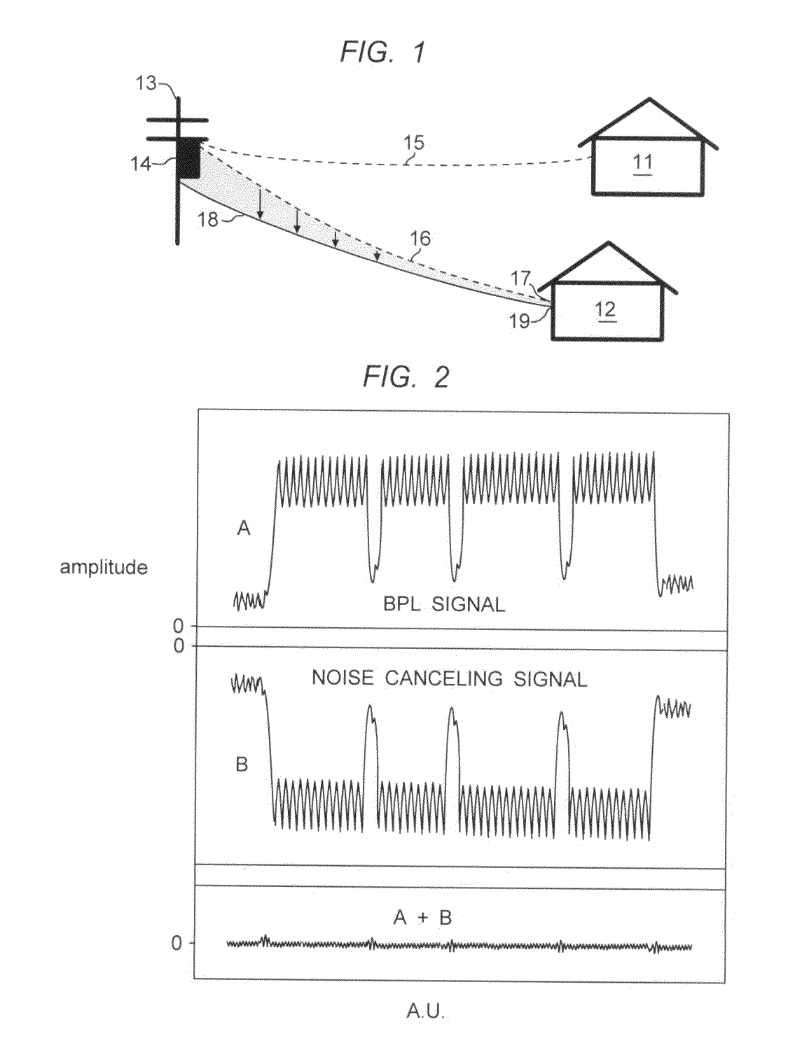

With reference to FIG. 1, two customer sites 11, 12, are shown. A utility pole for service delivery is shown at 13. A power transformer, mounted on the utility pole, is shown at 14. The customer in premises 11 has BPL service provided over a conventional power drop line 15. The customer in premises 12 may have BPL service, provided over a conventional power drop line 16, and attached to the premises 12 at 17, as well as EDSL service, provided over DSL drop line 18, attached to the premises at 19.

The unwanted interference in FIG. 1 is represented by the arrows between drop lines 16 and 18. While the points of coupling shown in FIG. 1 are common, coupling between BPL and EDSL signals may occur at other points, for example, along the delivery lines to the utility pole, at the utility pole, or, if the connection points 17 and 19 are close, at the premises. Also, the customer in premises 12 may not have BPL service, but still receive BPL interference from another's premises.

Where the proximity effects, and the resulting interference, are unavoidable or not easily remedied, the solution of this invention is valuable. That solution is to sample the power line signal, and use that sample to derive a noise-canceling signal. The noise-canceling signal will replicate the noise signal on the EDSL line caused by unwanted BPL coupling.

Noise canceling methods are well known and widely used. In principle, the most straightforward approach is to split the incoming noisy signal, filter the frequency of the wanted signal with a narrow bandpass filter, leaving a noise signal that contains only the noise components of the incoming signal. The noise signal is inverted, and mixed with the incoming signal that was initially split off. Inverting the noise signal is equivalent to summing the signals in a plus/minus summing device. In this manner, the noise components are canceled. These circuits may contain one or more variable delay elements to synchronize the split paths in the time domain.

In the case described here, the BPL signal that is sampled from the power line represents all noise. The BPL information component of the BPL signal is noise to the EDSL service. Accordingly, the noise canceling implementation is simplified from that standpoint. However, it is useful to add a filtering stage to remove the AC power component from the power line signal. Additionally, the method in this case is complicated by the fact that the amount of coupling between the BPL and EDSL lines is unknown, and not necessarily static. Thus the noise canceler in this case measures the amplitude of the noise in the EDSL signal, and creates a relative adjustment between that and the amplitude of the noise in the BPL signal. When the BPL signal is mixed with the EDSL signal in a plus/minus summing junction, the noise is effectively cancelled.

The noise canceling mechanism is represented schematically in FIG. 2, where the BPL signal is shown at A in the top trace, and the noise canceling signal is shown at B in the middle trace. These signals are combined in the bottom trace, A+B, effectively canceling the noise A.

The noise canceling function described in FIG. 2 is typically implemented using adaptive interference canceling methods. A well-known adaptive interference canceling method is the Least Mean Square, or LMS, method. These methods use a wide variety of circuit designs. Chapter 12 et al. of the textbook, “Adaptive Signal Processing” by Widrow and Sterns, Prentiss-Hall, 1985, provide a basic description of useful circuits. For essential details, this text is incorporated herein by reference.

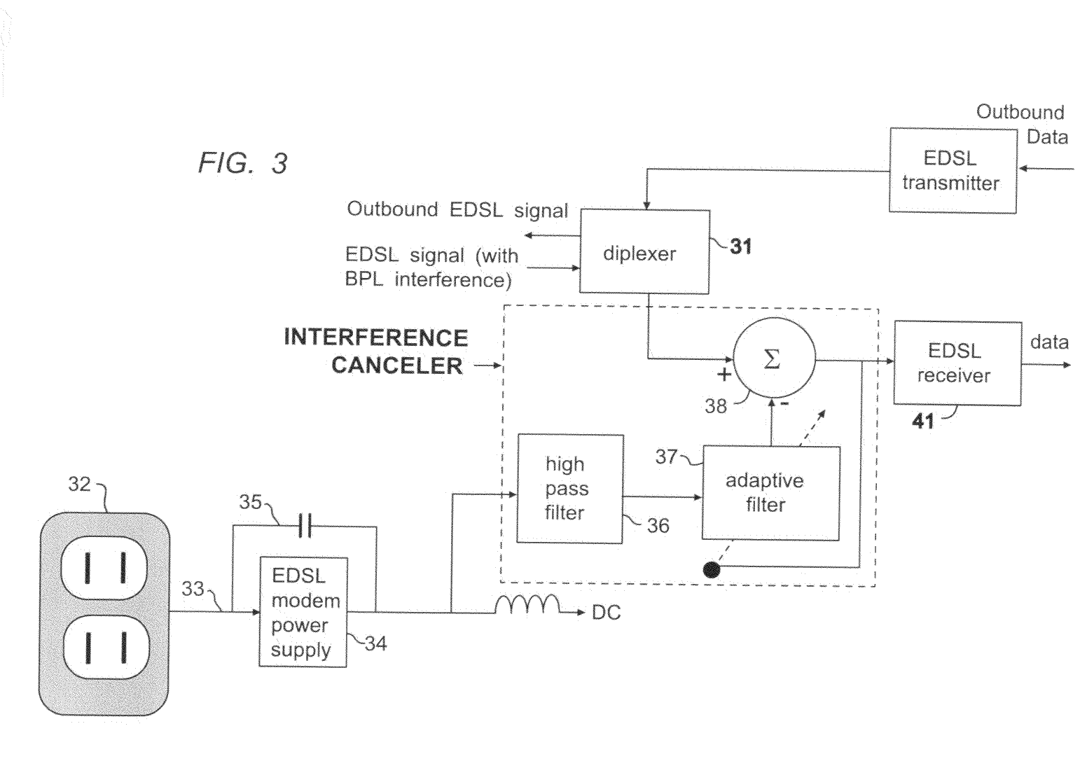

A typical circuit for implementing the noise canceling function described here is shown in FIG. 3. The familiar signal+noise input to the noise canceler in FIG. 3 is the EDSL signal input to diplexer 31. The noise signal is derived from the electrical utility power supply, represented by wall receptacle 32. This signal contains both the standard AC power signal, plus the BPL signal, which for the purpose of this discussion is the noise. The EDSL modem power supply 34 may conveniently be plugged into this wall receptacle to receive the noise signal. Other arrangements, for example, a permanent power connection, may be used. The connection 33, between the EDSL modem and the utility power supply (plus BPL) is an important element of the invention. Bypass 35 is an optional feature, which may be used to obtain sufficient BPL power to the modem in cases where the modem power supply uses a wall transformer.

The INTERFERENCE CANCELER includes the components within the dashed line of FIG. 3. These, or equivalent components, comprise the attachment to the EDSL service used to implement the invention. The high pass filter 36 passes the BPL signal, and any noise associated with the BPL signal. The BPL signal is fed to the adaptive filter 37. The output of the adaptive filter is mixed with the EDSL signal at summing junction 38. The adaptive filter 37 automatically adjusts its response so as to minimize the amount of BPL interference arriving at the EDSL receiver 41.

The device configuration shown in FIG. 3 is given by way of example only. The basic details of the noise canceler are well known and themselves form no part of the invention. The aspect of the invention to be emphasized is the derivation of the signals introduced into the INTERFERENCE CANCELER.

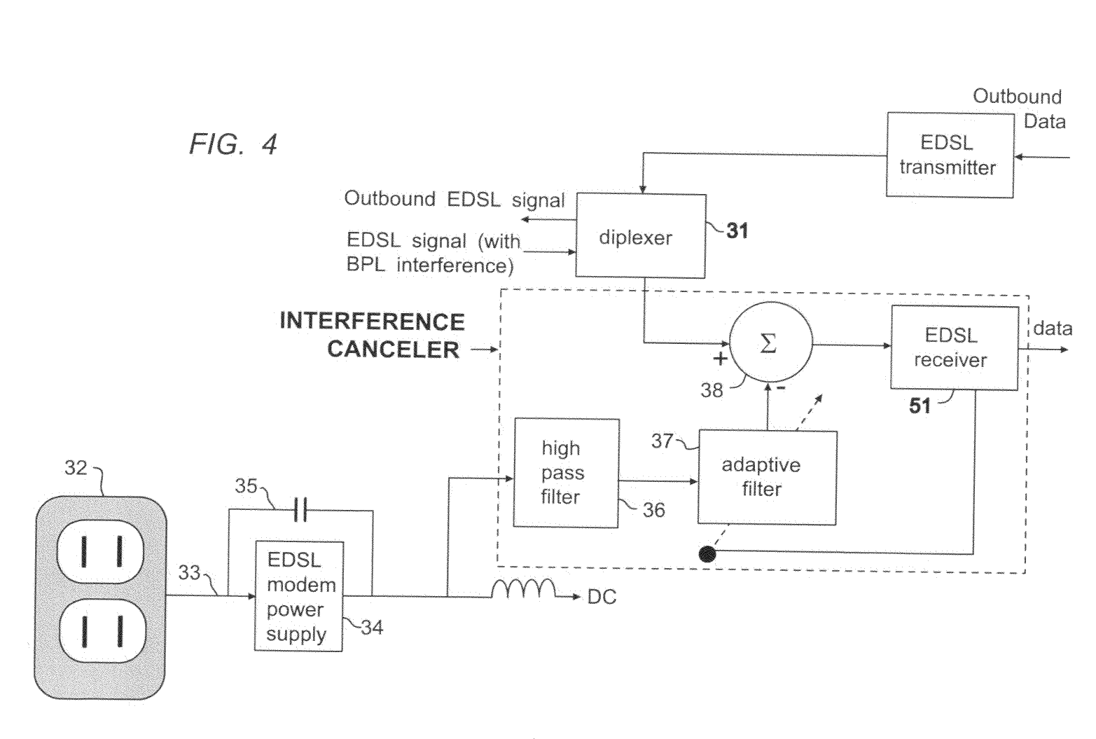

An integrated version of the EDSL modem, where the INTERFERENCE CANCELER is integrated with the modem is represented in FIG. 4. Here the EDSL receiver 51 contains the adaptive equalizer.

It should be emphasized that the BPL noise canceling method of the invention can be implemented without involvement or cooperation between the EDSL user and the BPL provider. This eliminates the often-complex issues of placing, and assuming, responsibility for BPL noise and remediation between the EDSL provider, the EDSL user, the BPL user, and the BPL provider. Either the EDSL provider, or the EDSL user, may implement noise reduction of BPL interference independent of other parties.

Various additional modifications of this invention will occur to those skilled in the art. All deviations from the specific teachings of this specification that basically rely on the principles and their equivalents through which the art has been advanced are properly considered within the scope of the invention as described and claimed.

1. Method for canceling BPL interference coupled between a BPL signal and an EDSL signal using an interference canceler comprising:
sampling the BPL signal from a BPL power line to provide a BPL signal sample,
inputting the BPL signal sample to the interference canceler,
inputting the EDSL signal to the interference canceler,
summing the BPL signal and the EDSL signal to cancel the noise.

2. The method of claim 1 wherein the interference canceler comprises an adaptive filter.

3. The method of claim 2 wherein the interference canceler implements a least mean squared function.

4. The method of claim 1 wherein the step of sampling the BPL signal comprises plugging into a receptacle on a customer premises.

5. The method of claim 2 wherein the BPL signal is filtered to remove the AC power line components.

6. The method of claim 1 wherein the EDSL signal comprises an EDSL modem.

7. The method of claim 6 wherein the interference canceler and the EDSL modem are contained in an integrated device.

8. A system for canceling BPL interference coupled between a BPL signal and an EDSL signal using an interference canceler comprising:
a BPL sampling device for sampling the BPL signal,
an EDSL signal source,
an interference canceler coupled to the sampling device and the EDSL signal.

9. The system of claim 8 wherein the interference canceler comprises an adaptive filter.

10. The system of claim 9 wherein the interference canceler implements a least mean squared function.

11. The system of claim 8 wherein the sampling device comprises a plug for plugging into a receptacle on a customer premises.

12. The system of claim 8 further comprising a high pass filter to remove the AC power line components.

13. The system of claim 12 wherein the EDSL signal source comprises an EDSL modem.

14. The system of claim 13 wherein the high pass filter and the adaptive filter comprise a module adapted to be connected to an EDSL source.

15. The system of claim 14 wherein the module is integrated with the EDSL modem.
